(19) United States
(12) Patent Application Publication
(10) Pub. No.: US 2005/0196044 A1
(43) Pub. Date: Sep. 8, 2005

(54) Method of extracting candidate human region within image, system for extracting candidate human region, program for extracting candidate human region, method of discerning top and bottom of human image, system for discerning top and bottom, and program for discerning top and bottom

(76) Inventors: Toshinori Nagahashi, Nagano-ken (JP); Takashi Hyuga, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/043,908

(22) Filed: Jan. 26, 2005

(30) Foreign Application Priority Data
Jan. 27, 2004 (JP) 2004-018376

(51) Int. Cl. G06K 9/46; G06K 9/34

(52) U.S. Cl. 382/190; 382/173

(57) ABSTRACT

A method is provided for extracting a candidate human image region from within a picture image. The top-bottom direction of a picture image containing a human image is discerned. Based on the result of the discernment, the human image is modified to the actual top-bottom direction. Then, the variance values of image features are found about vertical and horizontal lines comprising vertical and horizontal rows of pixels constituting the picture image. Regions having variance values of image features in excess of their threshold values are selected about the vertical and horizontal line directions. An area within the picture image in which the selected regions in the line directions overlap with each other is extracted. Thus, an area within the picture image in which the human image exists can be robustly and quickly extracted.

### RELATED APPLICATIONS

This application claims priority to Japanese Patent Application No. 2004-018376 filed Jan. 27, 2004 which is hereby expressly incorporated by reference herein in its entirety.

### BACKGROUND

1. Technical Field

The present invention relates to pattern recognition and object recognition technique and, more particularly, to a method of extracting a candidate human image region from within a picture image, a system for extracting the candidate human image region, a program for extracting the candidate human image region, a method of discerning the top and bottom of a human image, a system for discerning the top and bottom, and a program for discerning the top and bottom in order to discern the top and bottom of a picture image containing a human image and to extract a region in which a person is highly likely to be present from within the picture image.

2. Related Art

In recent years, as pattern recognition technology and information-processing apparatuses such as computers have improved in performance, the accuracy at which characters and voice are recognized by machines has improved at an amazing rate. It is known, however, that it is still difficult to recognize persons, objects, and scenes within images taken, for example, by a still image camera by pattern recognition technology, and that it is especially quite difficult to precisely and quickly recognize whether a human face is contained in such an image.

However, it has become quite important to recognize whether a human face is contained in such an image and to identify who is in the picture precisely and automatically using a computer or the like in establishing biometric recognition technology, improving security, speeding up criminal investigations, increasing the rates at which image data are put in order, and speeding up search operations.

In order to establish a face recognition technique that is quite useful in future in this way, a technique for detecting a region within a detected image in which a human face exists as quickly as possible and precisely and identifying the region is necessary.

For example, in JP-A-H9-50528 and so on, a region of flesh color within an image is first extracted. Mosaic data is created according to the extracted region and compared with an image dictionary. The degree of similarity is calculated. Thus, a facial image region is detected.

However, a region of flesh color is not always coincident with a human facial region. There is the disadvantage that if a region of flesh color is defined broadly, an unwanted region is extracted, and conversely, if it is defined narrowly, a failure of extraction occurs.

On the other hand, where a picture image from which a facial image should be detected is searched for a human face at high speed, it is important to narrow down the search region within the picture image as much as possible.

Accordingly, the present invention has been devised to effectively solve this problem. It is an object to provide novel method of extracting a candidate human image region from within a picture image, candidate human image region extraction system, candidate human image region extraction program, human image top-and-bottom discerning method, top-and-down discerning system, and top-and-down discerning program capable of discerning the top and bottom of the picture image containing a human image and of extracting a region of the picture image in which the human image exists robustly and quickly.

### SUMMARY

To solve the foregoing problem, a method of extracting a candidate human image region from within a picture image in accordance with aspect 1 is a method of extracting a region in which the human image exists from within the picture image containing the human image. The method starts with finding the variance values of image features about vertical and horizontal lines, respectively, comprising vertical and horizontal rows of pixels constituting the picture image. Regions having variance values of image features in excess of their threshold values are selected about the vertical and horizontal line directions, respectively. An area within the picture image in which the selected regions in the line directions overlap with each other is selected as the region in which the human image exists.

The variance values of the image features are found about the vertical and horizontal lines comprising vertical and horizontal rows, respectively, of pixels constituting the picture image in this way, for the following reason. Generally, in cases where the background is formed by a uniform or given pattern as when an evidence photograph is taken, there is a tendency that a region containing a person produces a high variance value of image feature and that the background region not containing any person produces a low variance value of image feature as described in detail later.

Accordingly, threshold values are set for variance values of image features obtained about the vertical and horizontal line directions, respectively. Regions providing variance values in excess of their threshold values are selected. An area within the picture image in which the selected regions in the line directions overlap with each other is identified. Thus, the area within the picture image in which a human image exists can be robustly and quickly extracted.

To solve the foregoing problem, a method of extracting a candidate human image region from within a picture image in accordance with aspect 2 is a method of extracting a region in which the human image exists from within the picture image containing the human image. The method starts with discerning the top-bottom direction of the human image in the picture image. Based on the result of the discernment, the picture image is rotated to correct the human image to the actual top-bottom direction. Then, variance values of image features are found about vertical and horizontal lines, respectively, comprising vertical and horizontal rows of pixels constituting the picture image. With respect to each of the vertical and horizontal line directions, the regions having variance values of image features in excess of their threshold value are selected. An area in the picture image in which the selected regions in the line directions overlap with each other is extracted.

That is, in order to extract a region in which a human image exists robustly and quickly by making use of variance values of image features as in aspect 1, the premise that the top-bottom direction of the picture image that is the subject and the actual top-bottom direction are coincident must be satisfied. Therefore, in the present invention, the top-bottom direction of the human image within the picture image is first identified. The human image is modified to the actual top-bottom direction. Thus, the human face is brought into coincidence with the proper top-bottom direction.

After the modification of the position of the human face is ended in this way, the same processing as in aspect 1 is subsequently carried out. That is, variance values of image features are found about the vertical and horizontal lines, respectively, comprising vertical and horizontal rows, respectively, of pixels constituting the picture image. Then, threshold values are set about the variance values of the image features obtained about the vertical and horizontal line directions, respectively. Regions having values exceeding their threshold values are selected. An area within the picture image in which the selected regions in the line directions overlap with each other is identified.

Thus, the area within the picture image in which a human image exists can be robustly and quickly extracted, in the same way as in aspect 1. In addition, discernment and modification of the top-bottom direction of the human image within the picture image can be made automatically and so the area in which the human image is present can be extracted with greater ease.

A method of extracting a candidate human image region from within a picture image as set forth in aspect 3 is based on a method of extracting a candidate human image region from within a picture image as set forth in aspect 2 and further characterized in that when the picture image is surrounded by a polygonal frame having three or more angles and the human image contained in the picture image is a part principally comprising the upper half or head of a person, variance values of the image-characterizing values are found about rows of pixels constituting sides of the image frame or lines close to the sides, and the side providing the highest variance value or the side close to the line providing the highest variance value is taken as the ground side in discerning the top-bottom direction of the human image within the picture image.

That is, when the human image contained in the picture image that is the subject is a part principally comprising the upper half or head of a person, a part of the human image is normally interrupted at any side of the image frame.

Accordingly, the variance values of image features are found about the rows of pixels constituting the sides of the image frame or lines close to the sides. The side providing the highest variance value or the side close to the line providing the highest variance value can be regarded as a portion at which the human image is interrupted. Therefore, the top and bottom of the human image can be reliably and easily discerned by taking this side as the ground side.

A method of extracting a candidate human image region from within a picture image as set forth in aspect 4 is based on a method of extracting a candidate human image region from within a picture image as set forth in aspect 3 and further characterized in that plural lines in the picture image which are close to each other are selected, and that the average value of the variance values of the image features about the lines, respectively, is used.

Consequently, if noise and contamination exist near the sides of the picture image, misdetection by their effects is avoided. A precise variance value of each side can be found.

A method of extracting a candidate human image region from within a picture image as set forth in aspect 5 is based on a method of extracting a candidate human image region from within a picture image as set forth in any one of aspects 1 to 4 and further characterized in that every given number of lines in lateral and height directions of the picture image are used as the aforementioned vertical and horizontal lines.

The variance values of the image features may be calculated using all the lines in the width and height directions of the picture image. Where every given number of lines is used as in the present invention, the amount of information processed to obtain variance values is reduced greatly and, therefore, a region in which a human image is present can be extracted more quickly.

A method of extracting a candidate human image region from within a picture image as set forth in aspect 6 is based on a method of extracting a candidate human image region from within a picture image as set forth in any one of aspects 1 to 6 and further characterized in that the image features are calculated based on at least one of the edge intensities and hue angles of the pixels of the rows of pixels constituting the lines.

That is, the edges of the image can be calculated quickly by making use of a well-known edge detection operator. In addition, the effects of lighting can be reduced. Therefore, if they are adopted as image features, the variance values can be computed precisely and quickly.

On the other hand, where the difference in edge intensity between the background and the human image is small, the variance values can be computed precisely and quickly by using hue angles.

Furthermore, by adopting the kind of the image or both of them, if necessary, as image features, the variance values can be calculated more precisely and quickly.

A method of extracting a candidate human image region from within a picture image as set forth in aspect 7 is based on a method of extracting a candidate human image region from within a picture image as set forth in aspect 6 and further characterized in that the edge intensities use a Sobel edge detection operator.

That is, the most typical method of detecting rapid variations in gray level within a picture image is to find a derivative of gradation. Since the derivative of a digital image is replaced by a difference, an edge portion across which the gradation within the picture image varies rapidly can be effectively detected by taking the first-order derivative of the image within the face detection frame.

In addition, the present invention uses a well-known Sobel edge detection operator as this first-order edge detection operator (filter), the Sobel edge detection operator being excellent in terms of detection performance. As a consequence, edges of the human image within the picture image can be detected reliably.

A system for extracting a candidate human image region from within a picture image as set forth in aspect 8 is a system for extracting a region in which a human image exists from within the picture image containing the human image. The system comprises: an image reading portion for reading the picture image; an image feature calculation portion for calculating image features about vertical and horizontal lines, respectively, comprising rows of pixels constituting the picture image read by the image reading portion; a variance value calculation portion for finding variance values of the image features about vertical and horizontal line directions, respectively, obtained by the image feature calculation portion; and a candidate human image region detection portion for detecting a region in which the human image exists from regions in the line directions having the variance values of the image features in excess of their threshold values in the vertical and horizontal line directions, the variance values being obtained by the variance value calculation portion.

Thus, the area within the picture image in which a human image exists can be robustly and quickly extracted, in the same way as in aspect 1.

These operations and effects can be automatically accomplished by realizing these portions by making use of dedicated circuits or a computer system.

A system for extracting a candidate human image region from within a picture image as set forth in aspect 9 is a system for extracting a region in which a human image exists from within the picture image containing the human image. The system comprises: an image reading portion for reading the picture image; a top-bottom discerning portion for discerning a top-bottom direction of the human image within the picture image read by the image reading portion; a top-bottom modification portion for rotating the picture image based on results of the discernment done by the top-bottom discerning portion to modify the human image to an actual top-bottom direction; an image feature calculation portion for calculating image features about vertical and horizontal lines, respectively, comprising rows of pixels constituting the picture image whose top-bottom direction has been modified by the top-bottom modification portion; a variance value calculation portion for finding variance values of the image features about vertical and horizontal line directions, respectively, obtained by the image feature calculation portion; and a candidate human image region detection portion for detecting a region in which the human image exists from regions in the line directions having the variance values of the image features in excess of their threshold values in the vertical and horizontal line directions, the variance values being obtained by the variance value calculation portion.

Thus, the area within the picture image in which a human image exists can be robustly and quickly extracted, in the same way as in aspect 2.

These operations and effects can be automatically accomplished by realizing these portions by making use of dedicated, circuits or a computer system, in the same way as in aspect 8.

A system for extracting a candidate human image region from within a picture image as set forth in aspect 10 is based on a system for extracting a candidate human image region from within a picture image as set forth in aspect 9 and further characterized in that when the picture image is surrounded by a polygonal frame having three or more angles and the human image contained in the picture image is a part principally comprising the upper half or head of a person, the top-bottom discerning portion for discerning a top-bottom direction of the human image within the picture image finds variance values of image features about sides of the picture image or lines close to the sides and takes the side providing the highest variance value or the side close to the line providing the highest variance value as the ground side.

Thus, the side at which the human image within the image frame is interrupted can be detected, in the same way as in aspect 3. Therefore, the top and bottom of the human image within the picture image can be reliably and easily discerned.

A system for extracting a candidate human image region from within a picture image as set forth in aspect 11 is based on a system for extracting a candidate human image region from within a picture image as set forth in aspect 10 and further characterized in that the top-and-bottom discerning portion for discerning the top-bottom direction of the human image within the picture image selects plural close lines in the picture image and uses the average value of the variance values of image features about the lines.

Consequently, if noise and contamination exist near the sides of the picture image, misdetection by their effects is avoided. A precise variance value of each side can be found, in the same way as in aspect 4.

A system for extracting a candidate human image region, from within a picture image as set forth in aspect 12 is based on a system for extracting a candidate human image region from within a picture image as set forth in any one of aspects 9 to 11 and further characterized in that the image feature calculation portion uses every given number of lines in lateral and height directions of the picture image as the vertical and horizontal lines.

Thus, the amount of information processed to obtain variance values is reduced greatly and so the area in which the human image is present can be extracted more quickly, in the same way as in aspect 5.

A system for extracting a candidate human image region from within a picture image as set forth in aspect 13 is based on a system for extracting a candidate human image region from within a picture image as set forth in any one of aspects 9 to 12 and further characterized in that the image feature calculation portion calculates the image features based on at least one of edge intensities and hue angles of the pixels of the rows of pixels constituting the lines.

Thus, the variance values of the image features can be computed more precisely and quickly, in the same way as in aspect 5.

A system for extracting a candidate human image region from within a picture image as set forth in aspect 14 is based on a system for extracting a candidate human image region from within a picture image as set forth in aspect 13 and further characterized in that the image feature calculation portion calculates the edge intensities using Sobel edge detection operators.

Thus, the edge portions of the picture image can be detected reliably in the same way as in aspect 7.

A program for extracting a candidate human image region from within a picture image as set forth in aspect 15 is a program for extracting the region in which a human image exists from within the picture image containing the human image. The program acts to cause a computer to perform functions of: an image feature calculation portion for calculating image features about vertical and horizontal lines, respectively, comprising rows of pixels constituting the picture image; a variance value calculation portion for finding variance values of image features about vertical and horizontal line directions, respectively, obtained by the image feature calculation portion; and a candidate human image region detection portion for detecting a region in which the human image exists from regions in the line directions having the variance values of the image features in excess of their threshold values in the vertical and horizontal line directions, the variance values being obtained by the variance value calculation portion.

Thus, the same advantages as aspect 1 can be obtained. Furthermore, the functions can be accomplished in software using a general-purpose computer (hardware) such as a personal computer. Therefore, the functions can be realized more economically and easily than where a dedicated apparatus is created and used. Furthermore, in many cases, modifications and version-up grades (such as improvements) of the functions can be easily attained simply by rewriting the program.

A program for extracting a candidate human image region from within a picture image as set forth in aspect 16 is a program for extracting a region in which a human image exists from within the picture image containing the human image. The program acts to cause a computer to perform functions of: a top-bottom discerning portion for discerning a top-bottom direction of the human image within the picture image; a top-bottom modification portion for rotating the picture image based on results of the discernment done by the top-bottom discerning portion to modify the human image to an actual top-bottom direction; an image feature calculation portion for calculating image features about vertical and horizontal lines, respectively, comprising rows of pixels constituting the picture image whose top-bottom direction has been modified by the top-bottom modification portion; a variance value calculation portion for finding variance values of the image features in vertical and horizontal line directions, respectively, obtained by the image feature calculation portion; and a candidate human image region detection portion for detecting a region in which the human image exists from regions in the line directions having the variance values of the image features in excess of their threshold values in the vertical and horizontal line directions, the variance values being obtained by the variance value calculation portion.

Thus, the same advantages as aspect 2 can be obtained. Furthermore, the functions can be accomplished in software using a general-purpose computer (hardware) such as a personal computer in the same way as in aspect 15. Therefore, the functions can be realized more economically and easily than where a dedicated apparatus is created and used. Furthermore, in many cases, modifications and version-up grades (such as improvements) of the functions can be easily attained simply by rewriting the program.

A program for extracting a candidate human image region from within a picture image as set forth in aspect 17 is based on a program for extracting a candidate human image region from within a picture image as set forth in aspect 16 and further characterized in that when the picture image is surrounded by a polygonal frame having three or more angles and the human image contained in the picture image is a part principally comprising the upper half or head of a person, the top-and-bottom discerning portion for discerning the top-bottom direction of the human image within the picture image finds the variance values of the image features about the sides of the picture image or lines close to the sides and takes the side providing the highest variance value or the side close to the line providing the highest variance value as the ground side.

Thus, the same advantages as aspect 3 can be obtained. Furthermore, the invention can be realized more economically and easily, in the same way as in aspect 15.

A program for extracting a candidate human image region from within a picture image as set forth in aspect 18 is based on a program for extracting a candidate human image region from within a picture image as set forth in aspect 17 and further characterized in that the top-and-bottom discerning portion discerns the top-bottom direction of the human image within the picture image selects plural close lines in the picture image and uses the average value of the variance values of image-characterizing values about the lines.

Thus, precise variance values can be found in the same way as in aspect 4. Furthermore, the invention can be accomplished more economically and easily, in the same way as in aspect 15.

A program for extracting a candidate human image region from within a picture image as set forth in aspect 19 is based on a program for extracting a candidate human image region from within a picture image as set forth in any one of aspects 15 to 18 and further characterized in that the image feature calculation portion uses every given number of lines in the lateral and height directions of the picture image as the aforementioned vertical and horizontal lines.

Thus, in the same way as in aspect 5, a region in which a human image is present can be extracted more quickly. Furthermore, in the same way as in aspect 15, the invention can be accomplished more economically and easily.

A program for extracting a candidate human image region from within a picture image as set forth in aspect 20 is based on a program for extracting a candidate human image region from within a picture image as set forth in any one of aspects 15 to 19 and further characterized in that the image feature calculation portion calculates the image features based on at least one of the edge intensities and hue angles of the pixels in the rows of pixels constituting the lines.

Thus, in the same way as in aspect 6, the variance values of the image features can be calculated more precisely and quickly. Furthermore, in the same way as in aspect 15, the invention can be accomplished more economically and easily.

A program for extracting a candidate human image region from within a picture image as set forth in aspect 21 is based on a program for extracting a candidate human image region from within a picture image as set forth in aspect 20 and further characterized in that the image feature calculation portion calculates the edge intensities using Sobel edge detection operators.

Thus, in the same way as in aspect 7, the edge portions of the picture image can be detected reliably. Furthermore, the program can be realized more economically and easily, in the same way as in aspect 15.

A method of discerning top-bottom direction of a human image as set forth in aspect 22 is a method of discerning the top-bottom direction of a human image within a picture image in which the human image is present within a polygonal frame having three or more angles, the human image principally comprising the upper half or head of a person. The method starts with finding the variance values of image features of rows of pixels constituting the sides of the picture image or lines close to the sides. The side providing the highest variance value or the side close to the line providing the highest variance value is identified as the ground side.

That is, in the case of a picture image in which a human image principally comprising the upper half or head of a person exists within a polygonal frame having three or more angles, a part of the human image is normally interrupted at any side of the image frame.

Accordingly, the variance values of image features are found about the rows of pixels forming the sides of the image frame or lines close to the sides. The side providing the highest variance value or the side close to the line providing the highest variance value can be regarded as a portion at which the human image is interrupted.

Therefore, the top and bottom of the human image can be reliably and easily discerned by taking the side at which the human image is interrupted as the ground side.

A system for discerning top-bottom direction of a human image as set forth in aspect 23 is a system for discerning the top-bottom direction of the human image within a picture image in which a human image principally comprising the upper half or head of a person exists within a polygonal frame having three or more angles. The system comprises: a variance value calculation portion for calculating variance values of image features of rows of pixels forming the sides of the picture image or lines close to the sides; and a top-and-bottom discerning portion for identifying the side providing the highest variance value or the side close to the line providing the highest variance value as the ground side, the highest variance value being obtained by the variance value calculation portion.

Thus, in the same way as in aspect 22, the top and bottom of the human image can be reliably and easily discerned. Furthermore, the discernment can be done automatically by realizing the processing by making use of dedicated circuits or a computer system.

A program for discerning top-bottom direction of a human image as set forth in aspect 24 is a program for discerning the top-bottom direction of the human image within a picture image in which the human image principally comprising the upper half or head of a person exists within a polygonal frame having three or more angles. The program acts to cause a computer to perform functions of: a variance value calculation portion for calculating variance values of image features of rows of pixels constituting the sides of the picture image or lines close to the sides; and a top-and-bottom discerning portion for identifying the side providing the highest variance value or the side close to the line providing the highest variance value as the ground side, the highest variance value being obtained by the variance value calculation portion.

Thus, in the same way as in aspect 22, the top and bottom of the human image can be reliably and easily discerned. Furthermore, the functions can be realized in software using a general-purpose computer (hardware) such as a personal computer. Therefore, the functions can be more economically and easily accomplished than where a dedicated apparatus is created and used. Furthermore, in many cases, modifications and version-up grades (such as improvements) of the functions can be easily attained simply by rewriting the program.

### BRIEF DESCRIPTION OF THE DRAWINGS

FIG. 1 is a block diagram showing one embodiment of a system for extracting a candidate human image region in accordance with the present invention.

FIG. 2 is a schematic view showing hardware that can be used in the system of the present invention.

FIG. 3 is a flowchart showing flow of processing of the method of extracting a candidate human image region in accordance with the invention.

FIG. 4 is a view showing one example of a picture image from which a candidate human image is to be extracted.

FIGS. 5(a) and (b) are diagrams illustrating Sobel operators.

FIG. 6 is a diagram showing variations in the variance values of image features of each line in the vertical and horizontal directions.

FIG. 7 is a conceptual diagram showing a state in which regions having variance values in excess of their threshold values overlap with each other.

### DETAILED DESCRIPTION

The best mode for carrying out the present invention is hereinafter described in detail with reference to the accompanying drawings.

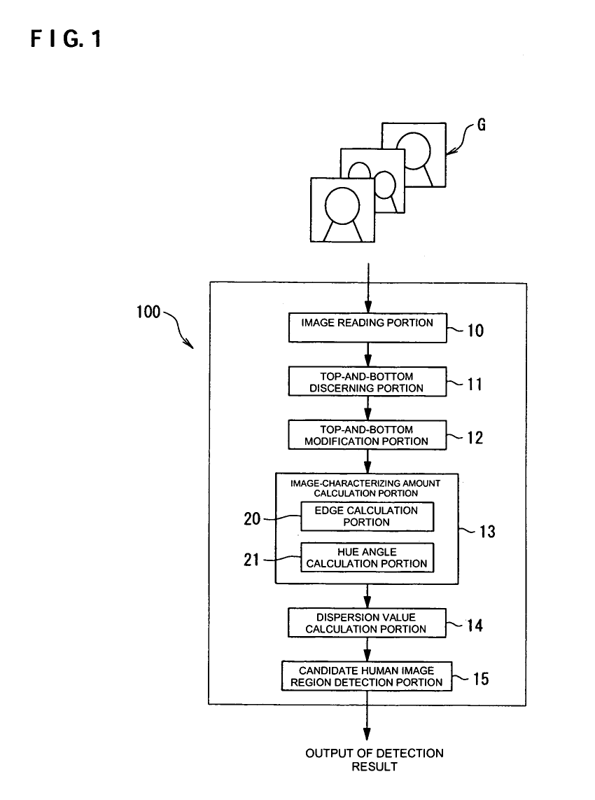

FIG. 1 shows one embodiment of a system 100 for extracting a candidate human image region from within a picture image, the system being associated with the present invention.

As shown, this system 100 for extracting a candidate human image region principally comprises an image reading portion 10 for reading a picture image G from which a candidate human image region is to be extracted, a top-and-bottom discerning portion 11 for discerning the top-bottom direction of a human image within the picture image G read by the image reading portion 10, a top-and-bottom modification portion 12 for modifying the human image to the actual top-bottom direction based on the result obtained by the top-and-bottom discerning portion 11, an image feature calculation portion 13 for calculating the image feature of the picture image G whose top-bottom direction has been modified by the top-and-bottom modification portion 12, a dispersion amount calculation portion 14 for finding the variance value of the image feature obtained by the image feature calculation portion 13, and a candidate human image region detection portion 15 for detecting a region in which the human image exists based on the variance value of the image feature obtained by the dispersion amount calculation portion 14.

First, the image reading portion 10 provides a function of reading the picture image G as digital image data comprising pixel data sets about R (red), G (green), and B (blue) by making use of an image sensor such as a CCD (charge-coupled device) image sensor or CMOS (complementary metal oxide semiconductor) image sensor and accepting the data sets. Examples of the image G include an evidence photograph (such as for a passport or a driver's license) and some snapshots in which the background is uniform or does not vary complexly. The image G includes a rectangular frame within which a human image principally comprising the upper half or head of a person is contained.

In particular, the reading portion is a CCD camera or CMOS camera (such as a digital still camera or digital video camera), vidicon camera, image scanner, drum scanner, or the like. The reading portion offers functions of converting the analog facial image G optically read into the image sensor into digital form and sending the digital image data to the top-and-bottom discerning portion 11 in succession.

The image reading portion 10 is fitted with a function of storing data, and can appropriately store the facial image data read in onto a storage device such as a hard disk drive (HDD) or a storage medium such as a DVD-ROM. Where the image G is supplied as digital image data via a network, storage medium, or the like, the image reading portion 10 is dispensed with or functions as a communications means (such as a DCE (data circuit terminating equipment), CCU (communication control unit), or CCP (communication control processor)) or interface (I/F).

The top-and-bottom discerning portion 11 provides a function of discerning the top-bottom direction of the picture image G having a polygonal image frame within which a human image is present. The polygonal image frame has three or more angles. The human image principally comprises the upper half or head of a person. The discerning portion detects one side of the image frame at which the human image is interrupted. This side is taken as the ground side. Thus, the top-bottom direction of the image G is discerned.

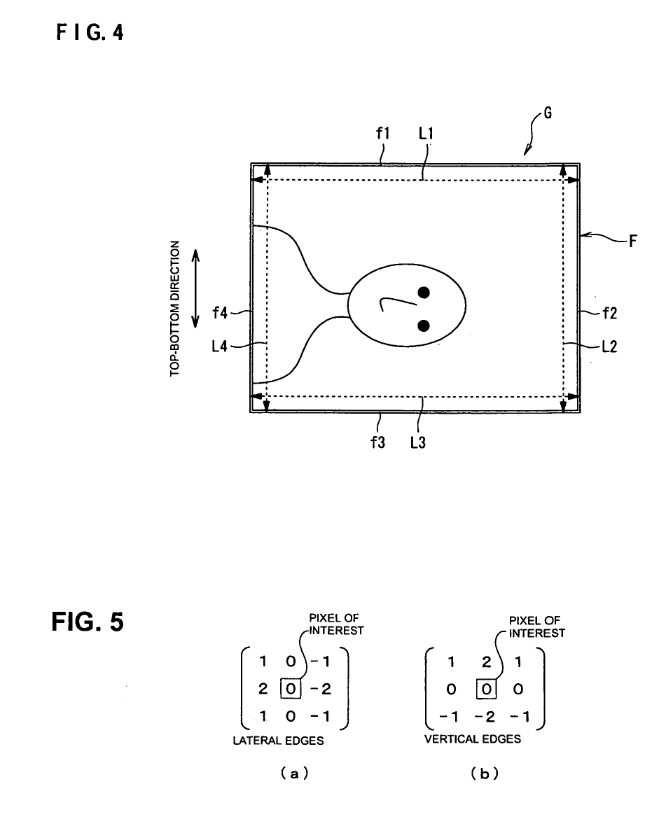

For example, where the picture image G read by the image reading portion 10 has a rectangular image frame F within which a human image comprising the upper half of a person, or substantially over the chest, exists as shown in FIG. 4, the top-bottom direction of the human image is discerned based on the variance values of image features obtained from rows of pixels forming the four sides f1, f2, f3, f4 of the image frame F or four lines L1, L2, L3, L4 established close to the sides. A specific method of calculating the variance values of the image features obtained from the rows of pixels forming the sides of the image frame F or the lines established close to the sides is described in detail later.

The top-and-bottom modification portion 12 provides a function of modifying the human image to the actual top-bottom direction based on the result of the discernment done by the top-and-bottom discerning portion 11. For example, in the embodiment of FIG. 4, the entire image G is rotated through 90° in a counterclockwise direction or 270° in a clockwise direction such that the left side, i.e., the side f4, on the side of which the human image is interrupted, is on the ground side. Thus, a modification is made to bring the top-bottom direction into coincidence with the actual top-bottom direction.

The image feature calculation portion 13 provides a function of calculating the image features of pixels forming the picture image G whose top-bottom direction has been modified by the top-and-bottom modification portion 12. In particular, at least one of the edge intensities and hue angles of the pixels of the rows of pixels constituting the vertical and horizontal lines comprising vertical and horizontal rows of pixels are detected by the edge calculation portion 20 or hue angle calculation portion 21. Based on the detected values, the image features of the pixels are computed.

The dispersion amount calculation portion 14 provides a function of finding the variance values of the image features obtained by the image feature calculation portion 13. A specific example is described later.

The candidate human image region detection portion 15 provides a function of detecting a region in which a human image exists based on the variance values of the image features obtained by the variance value calculation portion 14. The detection portion selects regions providing image features having variance values in excess of their threshold values about the vertical and horizontal line directions, respectively, and extracts an area within the picture image in which the selected regions in the line directions overlap with each other as a region in which the human image exists.

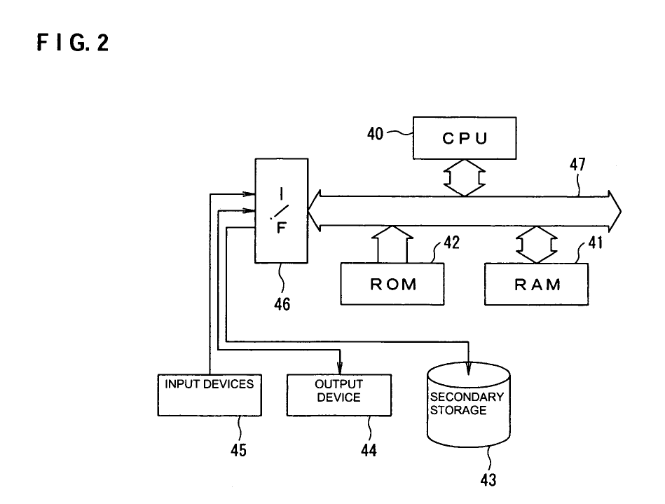

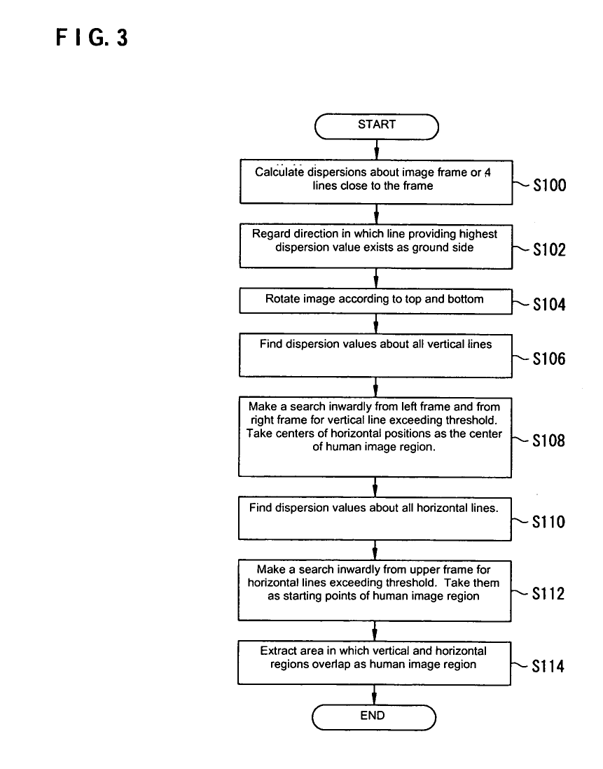

The portions 10, 11, 12, 13, 14, 15, and so on constituting the system 100 for extracting a candidate human image region in accordance with the present invention described so far are realized in practice by a computer system, such as a personal computer, comprising hardware made up of a CPU, a RAM, and so on as shown in FIG. 2 and a dedicated computer program (software) describing an algorithm as shown in FIG. 3 and other figures.

That is, as shown in FIG. 2, the hardware for realizing the candidate human image region extraction system 100 includes a CPU (central processing unit) 40 that performs various control operations and arithmetic operations, the RAM (random access memory) 41 used in a main storage, a ROM (read-only memory) 42 that is a storage device for reading purposes only, a secondary storage 43 such as a hard disk drive (HDD) or semiconductor memory, an output device 44 such as a monitor (e.g., an LCD (liquid-crystal display) or a CRT (cathode-ray tube)), input devices 45 comprising an image scanner, a keyboard, a mouse, and an image sensor (such as CCD (charge-coupled device) image sensor or CMOS (complementary metal oxide semiconductor) image sensor), input/output interfaces (I/F) 46 for the devices, and various internal and external buses 47 connecting the input/output interfaces. The buses 47 include processor buses comprising PCI (peripheral component interconnect) or ISA (industrial standard architecture) buses, memory buses, system buses, and input/output buses.

Various programs for controlling purposes and data are installed into the secondary storage 43 or the like. The programs and data are supplied via a storage medium such as a CD-ROM, DVD-ROM, or flexible disk (FD) or via a communications network (such as LAN, WAN, or Internet) N. If necessary, the programs and data are loaded into the main storage 41. According to the programs loaded in the main storage 41, the CPU 40 makes full use of various resources to perform given control and arithmetic processing. The results of the processing (i.e., processed data) are output to the output device 44 via the buses 47 and displayed. If necessary, the data are appropriately stored in a database created by the secondary storage 43 or the database is updated.

One example of the method of extracting a candidate human image region using the system 100 constructed in this way for extracting a candidate human image region in accordance with the present invention is next described with reference to FIGS. 4-7.

FIG. 3 is a flowchart illustrating one example of flow of processing regarding extraction of a candidate human image region, the processing being according to the present invention.

First, if the subject image G is read by the image reading portion 11, as illustrated in the first step S100, the image features of the pixels forming the sides constituting the image frame of the image G or lines close to the sides are calculated. Furthermore, the variance values of the image features are computed. For example, where the image G read by the image reading portion 11 has a rectangular image frame F as shown in FIG. 4, the frame F includes four sides f1, f2, f3, and f4 and so image features based on at least one of the edge intensities and hue angles are calculated about the pixels forming the four sides f1, f2, f3, and f4 or about the pixels forming lines L1, L2, L3, and L4 which are close to the sides f1, f2, f3, f4 and extend parallel to the sides f1, f2, f3, f4.

The “edge intensities” and “hue angles” referred to herein have the same meanings as generally defined in the image processing field.

That is, each edge intensity can be easily calculated, for example, by previously calculating the brightness (Y) of each pixel and using a well-known first-order derivative (differential type) edge detection operator typified by a Sobel edge detection operator and based on the brightness value.

FIGS. 5(a) and (b) show such Sobel edge detection operators. The operator (filter) shown in (a) of FIG. 5 enhances the horizontal edges by adjusting the values of three pixels located on the left and right columns out of the values of 8 pixels surrounding a pixel of interest. The operator shown in (b) of FIG. 5 enhances the vertical edges by adjusting the values of three pixels located on the upper row and lower column out of the values of 8 pixels surrounding the pixel of interest. In this way, the vertical and horizontal edges are detected. The sum of the squares of the results produced by the operators is taken. Then, the root square of the sum is taken. As a result, the edge intensity can be found. Furthermore, instead of the Sobel operators, other first-order derivative edge detection operators such as Roberts and Prewitt operators can be used.

Meanwhile, the hue angle is an attribute indicating a color difference. The “hue angle” is the angle to the position of the color of the hair with respect to the background color when a color index chart such as the Munsell hue circle or Munsell color solid is used. For example, according to the Munsell hue circle, in a case where the reference background color is blue, it follows that with respect to the hair color, yellow and red have greater hue angles than green, i.e., have greater image features.

After the image features about the pixels forming the sides f1, f2, f3, f4 or the lines L1, L2, L3, L4 close to the sides are calculated in this way, the variance values of the image features of the sides f1, f2, f3, f4, respectively, or the lines L1, L2, L3, L4, respectively, close to the sides are calculated.

Then, the program goes to step S102, where that of the sides f1, f2, f3, f4 or lines L1, L2, L3, L4 close to them which provides an image feature having the highest one of the calculated variance values is selected. The portion at which the side or line is present is regarded as the ground side.

In the embodiment of FIG. 4, the sides f1, f2, f3, f4 or lines L1, L2, L3, and L4 close to the sides are made of uniform or little varying background except for the side f4 or line L4. A part (chest) of the person touches the side f4 or line L4. Therefore, the variance value of the image feature of the side f4 or line L4 is highest. As a result, the side f4 or line L4 at the left side of the figure is regarded as the ground side.

After the top-bottom direction of the picture image G from which a candidate human image region is extracted is discerned in this way, the program goes to step S104, where the image G is rotated according to the top-bottom direction.

In the embodiment of FIG. 4, the side f4 or the side of the line L4 is regarded as the ground side. Therefore, the picture image G is rotated through 90° in a counterclockwise direction or 270° in a clockwise direction such that the side f4 or the side of the line L4 faces the actual ground side as indicated by the arrows.

After rotating the picture image G and bringing its top-bottom direction into agreement with the actual top-bottom direction in this way, the program proceeds to the next step S106, where the variance values of the image features are found about all the vertical lines.

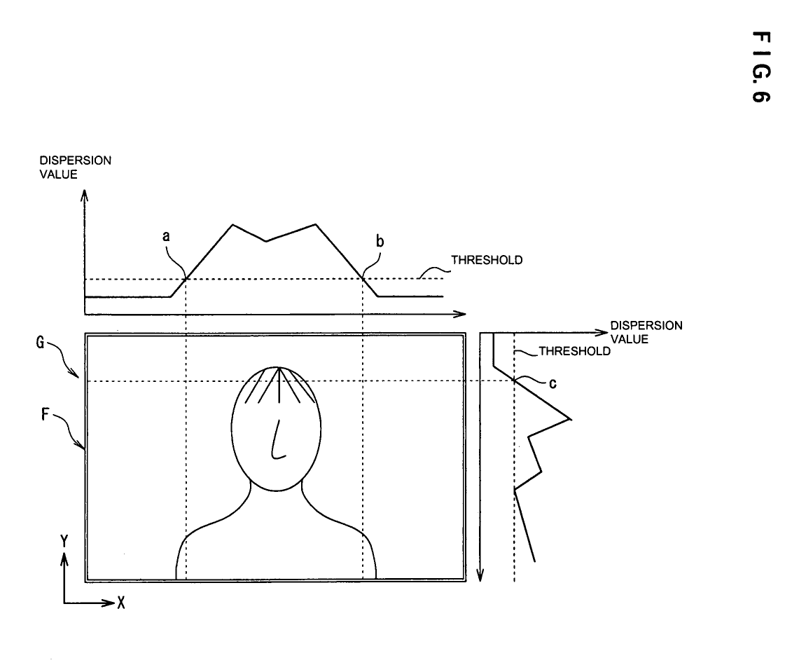

For example, where the picture image G includes 300 pixels (vertical) (Y-direction)×500 pixels (horizontal) (X-direction) as shown in FIG. 6, the variance value of the image feature of each vertical line comprising 300 pixels in a vertical row is calculated. Therefore, the variance values of the 500 vertical lines in total are computed.

After calculating the variance values of the image features of all the vertical lines in this way, the program goes to the next step S108, where a threshold value is set for the variance values. A search is made inwardly for vertical lines having values in excess of the threshold value from the left side (left frame portion) of the image G and from the right side (right frame portion) in turn. Regions having values exceeding the threshold value are regarded as candidate human image regions. The center of their horizontal positions is regarded as the center of the candidate human image regions.

In the embodiment of FIG. 6, a search is made inwardly from the left side (left frame portion) and from the right side (right frame portion) in turn. As a result, the threshold value is exceeded at points a and b. In the vertical direction, the interval between the points a and b is identified as a candidate human image region. Furthermore, the midpoint between the points a and b is identified as the center of the human image.

After the candidate human image region is identified in the vertical direction in this way, the program goes to the next step S110, where the variance values regarding all the horizontal lines are found at this time in the same way as in the foregoing processing. In the embodiment of FIG. 6, 300 pixels are arrayed in the vertical direction and so it follows that the variance values are found regarding 300 horizontal lines in total.

After finding the variance values regarding all the horizontal lines in this way, a threshold value is set for the variance values in the same way as in the above-described step S108. The program goes to the next step S112. A search is made downwardly from the upper side (upper frame portion) of the image G about horizontal lines exceeding the threshold value. The lower region exceeding the threshold value is regarded as a candidate human image region.

In the embodiment of FIG. 6, a search is performed downwardly from the upper side (upper frame side) in turn. As a result, the threshold value is exceeded at point c. Therefore, the region lower than the point c is identified as a candidate human image region in the horizontal direction. Furthermore, the neighborhood of the point c is identified as the top of the human image, i.e., head top. As mentioned previously, in this image G, the region into which a part of the human image extends is always located on the ground side. Therefore, it is not necessary to make a search from the lower side.

The program then goes to the next step S114. If regions exceeding the variance values in the vertical and horizontal directions, respectively, are identified, an area in which these regions overlap with each other is identified. Thus, this area can be extracted as a candidate human image region.

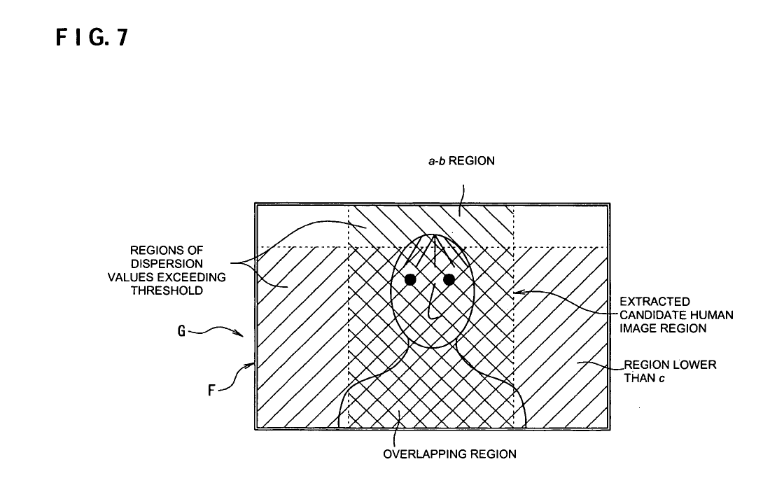

In the embodiment of FIG. 6, an area in which a-b region and the region lower than c overlap with each other is extracted as a candidate human image region as shown in FIG. 7.

A region where a person exists produces a high variance value of image feature. A background region in which no person exists produces a low variance value of image feature. The present invention discerns the top-bottom direction of the image in this way by making use of the tendency as described above. Each region having a variance value exceeding the threshold value is selected. An area within the picture image in which the selected regions in the line directions overlap with each other is extracted as a candidate human image region. Therefore, the top-bottom direction of the picture image G can be modified, of course. In addition, a region within the picture image G in which a human image exists can be robustly and quickly extracted.

In the present embodiment, a case of the picture image G having the rectangular image frame F has been described. Even in cases of triangular image frame F and polygonal image frames having more angles, their top-bottom directions can be easily discerned and a candidate human image can be extracted by a similar technique. Furthermore, in cases of image frames F in the form of a genuine circle or eclipse, if the outer periphery is regularly divided and a decision is made, the top-bottom direction can be discerned and a candidate human image region can be extracted, in the same way as in the case of the polygonal image frame F.

Additionally, no limitations are placed on the specific method of establishing the threshold value. Where a distinct difference in variance value of image feature is observed between the background portion and human image portion as shown in FIG. 6, if the threshold value is set to a lower value, a candidate human image region may be extracted more precisely. However, where no distinct difference is observed because an object other than a person is in the background or for other reason, it is necessary to set the threshold value to a higher value. It is considered that a normal appropriate threshold value is obtained by adding about one quarter (¼) of the maximum variance value to a variance value obtained near the image frame.

Where edge intensities are used as image features, high-speed calculations are enabled. In addition, the effects of illumination can be reduced. However, where an object other than a person is in the background and the difference in edge intensity between the background and the person is small, it is not appropriate to use edge intensities. Therefore, in such cases, use of hue angles can contribute more certainly to extraction of a candidate human image region.

With respect to the lines used for discernment of the top and bottom, if one line is available for each side, then the discernment can be done. Plural lines may be selected and the average value of the variance values of the lines may be used by taking account of noise and contamination in the image G. Where a candidate human image region is extracted, all the lines may be used. In addition, where some lines (e.g., every given number of lines) are appropriately used, the amount of calculation for variance values is reduced accordingly and greatly though the accuracy is somewhat inferior. Hence, a candidate human image region can be extracted more quickly.

Furthermore, in the present embodiment, discernment of the top-bottom direction of a human image within a picture image and a modification to it are done prior to extraction of the human image region. In cases where the top-bottom directions of the subject human images within a picture image are all coincident with the actual top-bottom direction, it is, of course, possible to omit these processing steps of discernment and modification.

1. A method of extracting a candidate human image region from within a picture image containing a human image, said method comprising the steps of:
finding variance values of image features about vertical and horizontal lines respectively including vertical and horizontal rows of pixels constituting said picture image;
selecting regions having variance values of image features in excess of threshold values about vertical and horizontal line directions; and
extracting an area within the picture image in which the selected regions in the line directions overlap each other as the region in which the human image exists.

2. A method of extracting a candidate human image region from within a picture image containing a human image, said method comprising the steps of:
discerning a top-bottom direction of the human image within said picture image;
rotating said picture image based on results of the discernment to modify said human image to an actual top-bottom direction;
thereafter finding variance values of image features about vertical and horizontal lines respectively including vertical and horizontal rows of pixels constituting said picture image;
selecting regions having variance values of image features in excess of threshold values about vertical and horizontal line directions; and
extracting an area within the picture image in which the selected regions in the line directions overlap each other as the region in which the human image exists.

3. A method of extracting a candidate human image region from within a picture image as set forth in claim 2, wherein:
when said picture image is surrounded by a polygonal frame having at least three angles and the human image contained in said picture image is a part principally including the upper half or head of a person, variance values of the image-characterizing values are found about rows of pixels constituting at least one of:
sides of the image frame; and
lines close to the sides; and
the side providing the highest variance value or the side close to the line providing the highest variance value is taken as a ground side in discerning the top-bottom direction of the human image within said picture image.

4. A method of extracting a candidate human image region from within a picture image as set forth in claim 3, wherein plural lines in said picture image which are close to each other are selected, and wherein an average value of variance values of image-characterizing values about the lines is used.

5. A method of extracting a candidate human image region from within a picture image as set forth in claim 2, wherein every given number of lines in lateral and height directions of said picture image are used as said vertical and horizontal lines.

6. A method of extracting a candidate human image region from within a picture image as set forth in claim 2, wherein said image features are calculated based on at least one of edge intensities and hue angles of the pixels of the rows of pixels constituting said lines.

7. A method of extracting a candidate human image region from within a picture image as set forth in claim 6, wherein said edge intensities use a Sobel edge detection operator.

8. A system for extracting a candidate human image region from within a picture image containing a human image, said system comprising:
an image reading portion for reading said picture image;
an image feature calculation portion for calculating image features about vertical and horizontal lines respectively including rows of pixels constituting the picture image read by said image reading portion;
a variance value calculation portion for finding variance values of the image features about vertical and horizontal line directions obtained by said image feature calculation portion; and
a candidate human image region detection portion for detecting a region in which the human image exists from regions in the line directions having the variance values of the image features in excess of threshold values in the vertical and horizontal line directions, the variance values being obtained by said variance value calculation portion.

9. A system for extracting a candidate human image region from within a picture image containing a human image, said system comprising:
an image reading portion for reading said picture image;
a top-bottom discerning portion for discerning a top-bottom direction of the human image within the picture image read by said image reading portion;
a top-bottom modification portion for rotating said picture image based on results of the discernment performed by said top-bottom discerning portion to modify said human image to an actual top-bottom direction;
an image feature calculation portion for calculating image features about vertical and horizontal lines respectively including rows of pixels constituting the picture image whose top-bottom direction has been modified by said top-bottom modification portion;
a variance value calculation portion for finding variance values of the image features about vertical and horizontal line directions obtained by said image feature calculation portion; and
a candidate human image region detection portion for detecting a region in which the human image exists from regions in the line directions having the variance values of the image features in excess of threshold values in the vertical and horizontal line directions, the variance values being obtained by said variance value calculation portion.

10. A system for extracting a candidate human image region from within a picture image as set forth in claim 9, wherein:
when the picture image is surrounded by a polygonal frame having at least three angles and the human image contained in the picture image is a part principally including the upper half or head of a person, the top-bottom discerning portion for discerning a top-bottom direction of the human image within said picture image finds variance values of image features about at least one of:
sides of the picture image; and
lines close to the sides; and
takes the side providing the highest variance value or the side close to the line providing the highest variance value as a ground side.

11. A program for extracting a candidate human image region from within a picture image containing a human image by causing a computer to perform functions of:
a top-bottom discerning portion for discerning a top-bottom direction of the human image within said picture image;
a top-bottom modification portion for rotating said picture image based on results of the discernment performed by said top-bottom discerning portion to modify said human image to an actual top-bottom direction;
an image feature calculation portion for calculating image features about vertical and horizontal lines respectively including rows of pixels constituting the picture image whose top-bottom direction has been modified by said top-bottom modification portion;
a variance value calculation portion for finding variance values of the image features about vertical and horizontal line directions obtained by said image feature calculation portion; and
a candidate human image region detection portion for detecting a region in which the human image exists from regions in the line directions having the variance values of the image features in excess of threshold values in the vertical and horizontal line directions, the variance values being obtained by said variance value calculation portion.

12. A program for extracting a candidate human image region from within a picture image as set forth in claim 11, wherein:
when said picture image is surrounded by a polygonal frame having at least three angles and the human image contained in said picture image is a part principally including the upper half or head of a person, the top-bottom discerning portion for discerning a top-bottom direction of the human image within said picture image finds variance values of image features about at least one of:
sides of the picture image; and
lines close to the sides; and
takes the side providing the highest variance value or the side close to the line providing the highest variance value as a ground side.

13. A method of discerning a top-bottom direction of a human image within a picture image in which the human image exists within a polygonal frame having at least three angles, the human image principally including the upper half or head of a person, said method comprising the steps of:
finding variance values of image features of rows of pixels constituting at least one of:
sides of said picture image; and
lines close to the sides; and
identifying the side providing the highest variance value or the side close to the line providing the highest variance value as a ground side.

14. A system for discerning top-bottom direction of a human image within a picture image containing the human image within a polygonal frame having at least three angles, the human image principally including the upper half or head of a person, said system comprising:
a variance value calculation portion for calculating variance values of image features of rows of pixels forming at least one of:
sides of said picture image; and
lines close to the sides; and
a top-and-bottom discerning portion for identifying the side providing the highest one of the variance values obtained by said variance value calculation portion or the side close to the line providing the highest one of the variance values obtained by said variance value calculation portion as a ground side.

15. A program for discerning top-bottom direction of a human image within a picture image containing the human image within a polygonal frame having at least three angles, the human image principally including the upper half or head of a person, said program comprising causing a computer to perform functions of:
a variance value calculation portion for calculating variance values of image features of rows of pixels forming at least one of:
sides of said picture image; and
lines close to the sides; and
a top-and-bottom discerning portion for identifying the side providing the highest one of the variance values obtained by said variance value calculation portion or the side close to the line providing the highest one of the variance values obtained by said variance value calculation portion as a ground side.
